(19) United States
(12) Patent Application Publication
(10) Pub. No.: US 2026/0311052 A1
(43) Pub. Date: Oct. 8, 2026

(54) MECHANISMS FOR INTELLIGENT MANAGEMENT AND COMMUNICATION OF DATA PREPARATION REQUIREMENTS AND CAPABILITIES IN FEDERATED MACHINE LEARNING

(71) Applicant: InterDigital Patent Holdings, Inc., Wilmington, DE (US)

(72) Inventors: Charles Aydin, Arlington, MA (US); Quang Ly, North Wales, PA (US); Dale Seed, Allentown, PA (US); Lu Liu, Conshohocken, PA (US)

(73) Assignee: InterDigital Patent Holdings, Inc., Wilmington, DE (US)

(21) Appl. No.: 19/482,958

(22) PCT Filed: May 8, 2024
(86) PCT No.: PCT/US2024/028288

§ 371 Date: Nov. 10, 2025

Related U.S. Application Data
(60) Provisional application No. 63/501,428, filed on May 11, 2023.

(51) Int. Cl. G06N 20/00

(52) U.S. Cl. CPC G06N 20/00

(57) ABSTRACT

Described herein are methods, apparatuses, and systems that enable the management and communication of machine learning data preparation requirements, client data availability, client data information, and client data processing capabilities in a FL system. An interface is defined between a FL user application and a FL service to enable the management and communication of the ML application and data preparation requirements for the FL process. Another interface is defined for the FL service to query FL clients for data availability and characteristics as well as data processing capabilities. The FL service may utilize the second interface to communicate data processing functions to the FL clients. These solutions ensure that the data used for training a machine learning model in a federated manner is standardized, meets the requirements of the ML model, processes efficiently and accurately, and utilizes the client's processing capabilities while preserving the privacy of the local client data.

### CROSS-REFERENCE TO RELATED APPLICATIONS

This application claims the benefit of U.S. Provisional Application No. 63/501,428 (“Mechanisms for Intelligent Management and Communication of Data Preparation Requirements and Capabilities in Federated Machine Learning”) filed May 11, 2023, the contents of which is hereby incorporated by reference in its entirety for any and all purposes.

### BACKGROUND

Machine learning (ML) is a field of computer science that gives computer systems the ability to “learn” with data (i.e., progressively improve performance on predicting metrics of interest), without being explicitly programmed. Training a ML model/system is the process of optimizing the parameters of a ML algorithm, or set of algorithms, and comparing the prediction results to the actual historical data of the metric(s) to be predicted, as a function of the corresponding historical data of its (their) drivers (features). Below is a general description of the overall ML lifecycle that is shown in FIG. 1.

The ML lifecycle is an iterative process that begins with an understanding of the business requirements and dynamics, which will lead to an understanding of the data. Subsequently data is prepared, for the training and validation of an ML model, which is then deployed, and starts being evaluated against the objectives of the business requirements. Based on the business requirements, an ML application is defined, and the data requirements are identified. An ML pipeline is then built where data collection and preparation are performed for the ML application. The prepared data is passed to an ML model for training, validation, and verification to ensure the model fulfills the business requirements. Once trained, the ML model is deployed for inferencing and the model's performance is monitored to ensure the inferencing results align with the goals of the ML application. If necessary, new data features may be collected, further data preparation may be employed and/or new algorithms may be explored to update the ML model, should it produce poor inferencing results, which may indicate model/data drift.

The data identification and preparation steps are very critical as any ML model is as accurate and effective as the quality of the data that it is trained with—a principle that is also known as garbage in, garbage out. As the data-centric ML paradigm is gaining more traction lately, the data quality related phases of the ML pipeline are only drawing more focus. Raw data often cannot be used for ML purposes for a plethora of reasons, including but not limited to project requirements, complex nonlinearities, statistical errors, model requirements, etc. ML algorithms may not work properly if data are not processed to meet the data input requirements of the algorithms. Consequently, in the traditional, more manual ML process, the data preparation is notoriously complex, laborious, tedious, and lengthy. Hence, much of the time is spent on data preparation by data scientists and engineers. Some of the most important steps in data preparation include:

Data Ingestion: Once appropriate data sources are identified, there is a need to establish automated accurate, consistent, and robust data ingestion mechanisms. This entails converging all data streams into a commonly discoverable and explorable environment, like a data warehouse (for ETL), or as it is becoming more popular with cloud computing becoming more widely used, a centralized storage (like a data lake) for an ELT process.

Exploratory Data Analysis (EDA): This involves analyzing the data for general patterns including but not limited to names and meanings of metrics, statistical measures such as mean, standard deviation, distributions, class imbalances, outliers, correlation, or other dependencies among features, etc.

Data cleaning: This involves removing or correcting inaccurate, incomplete, or irrelevant data. Common techniques include removing duplicate records, filling in missing values, correcting data entry errors, employing over/under sampling techniques against imbalances, etc.

Data augmentation: This involves generating additional training data by applying augmentation techniques to the existing data, such as rotating or flipping images.

Data transformation: This involves converting data into a format that can be used by a machine learning algorithm. Common techniques include encoding categorical variables, scaling numerical features (min-max scaling, normalizing etc.), and creating new features from existing features through feature engineering.

Data format consistency: This may involve standardizing storage as well as record formats (units, variable types, etc.).

Federated Learning (FL) is an approach to ML that enables the creation of models trained on data that is distributed across multiple clients or locations, without the need to aggregate and store data in one central location. An FL server manages multiple FL clients during ML training and/or inferencing and data is kept private and stored locally at the individual FL clients. ML model(s) and the associated parameters are exchanged between the FL server and the FL clients during training. The FL server aggregates the model parameters (e.g., weights) at each round of federated training and the FL training iterates for many rounds. This method has become increasingly popular in recent years as more and more organizations seek to harness the power of large datasets without compromising the privacy of individual users and/or data sources, with the added benefits of reduced data movement and improved scalability. However, FL also introduces several challenges, one of which is the preparation of data for analysis as required for ML applications.

Data preparation is a crucial step in the ML pipeline. In FL, data preparation becomes even more challenging because the data is stored locally and kept private at the individual clients, and each client may have different data characteristics and capabilities. As a result, training a ML model in a federated manner may impose separate data preparation requirements for different clients within a given FL network.

Data preparation in FL is challenging due to several reasons:

Privacy Concerns: The data may contain sensitive information, such as personal identifiable information or confidential business data. Therefore, data privacy is crucial, and the data must be protected from unauthorized access. As a result, the FL server does not have visibility into the data characteristics and therefore is not able to easily determine the data preparation and processing requirements for each client.

Data Heterogeneity: Each client's data may be different in terms of size, format, distribution, and quality. This heterogeneity may require different types of data preparation operations to be performed on each client. This heterogeneity may also affect the accuracy and fairness of the global model.

Communication Overhead: In FL, the parties involved (e.g., clients, servers, users) must communicate with each other to exchange information about the data, models, and updates. This communication may cause delays and increase the computational overhead. These communication delays and overhead may not be uniform and consistent (e.g., different clients may experience different communication delays and overhead).

Varying Degrees of Limited Resources: Each client may have different capabilities, such as computing power, storage, or network bandwidth. These limitations may affect the performance and scalability of some clients and limit their ability to perform data preparation operations in a consistent and timely manner.

As can be seen, data preparation for federated learning becomes more challenging than traditional ML data preparation, which is already challenging in and of itself. FL is a relatively new approach for ML and as such, there is a lack of services that address the shortcomings of data preparation for federated learning. A FL service needs to manage and communicate data preparation requirements to FL clients.

### SUMMARY

Federated learning systems enable machine learning models to be trained on data that is stored locally and kept private on the individual clients. As such, the management and communication of data preparation requirements, client data availability, client data characteristics and client data processing capabilities become crucial in such systems. However, there is a lack of mechanisms for the management and communication of this information and there is a need for a set of solutions to enable this capability for proper FL training and/or inferencing.

Described herein are methods, devices, and systems that enable the management and communication of machine learning data preparation requirements, client data availability, client data information, and client data processing capabilities in a FL system. An interface can be defined between a FL user application and a FL service to enable the management and communication of the ML application and data preparation requirements for the FL process. Another interface can be defined for the FL service to query FL clients for data availability and characteristics as well as data processing capabilities. The FL service may also utilize the second interface to communicate data processing functions to the FL clients. These solutions ensure that the data used for training a machine learning model in a federated manner can be standardized, meets the requirements of the ML model, processes efficiently and accurately, and utilizes the client's processing capabilities appropriately while preserving the privacy of the local client data.

According to the present disclosure, a FL service can include: receiving a request from a FL user comprising ML application use case information, wherein the information may comprise one or more of an FL identifier, an ML use case description, a type of ML algorithm, a target feature for inferencing, a list of mandatory and/or optional features for a dataset, a specified number of features, the data characteristics for each feature, optionally data preparation requirements for each feature, and a minimum or maximum dataset size; determining, based on the received information from the FL user, a required dataset for the ML use case: determining one or more FL client datasets which match the required dataset for the ML use case; sending a message to the FL user comprising information of the one or more FL client datasets; receiving a response from the FL user comprising an indication that one or more FL client datasets meet the requirements of the FL user; sending one or more exploratory data analysis (EDA) requests to one or more FL clients to query the FL clients for statistic information about the dataset, wherein the requests may comprise one or more of a dataset identifier, a dataset description, a targeted feature to predict, a list of required dataset features, data preparation requirements, and dataset statistics; receiving one or more EDA responses from the FL clients comprising query results for the information specified in the EDA request; processing EDA responses, wherein processing may comprise aggregating and/or anonymizing information from the received EDA responses, and/or determining data preparation requirements; sending EDA responses to the FL user; receiving data preparation requirements from the FL user, wherein the data preparation requirements may comprise specific requirements for specific FL clients, wherein the requirements may comprise information such as FL client or group ID, dataset identifier, feature identifier, required data formatting and preparation instructions; sending data preparation requests to one or more FL clients comprising data preparation instructions, wherein the instructions may comprise scripts, functions, or invocations to FL client APIs; receiving responses from the FL clients comprising FL client specific data preparation capabilities and needs such as required data preparation packages or tools; sending a response to a FL user to share FL client and/or client group specific data preparation capabilities and needs; receiving a request from a FL user comprising specific data preparation instructions and/or tools for specific FL clients and/or client groups; sending FL client specific instructions and tools to individual FL clients: receiving responses from the FL clients comprising data preparation status information; and sending FL client data preparation status information to the FL user, wherein the status information may be aggregated status information from multiple FL clients.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

FIG. 1 depicts an example ML lifecycle;

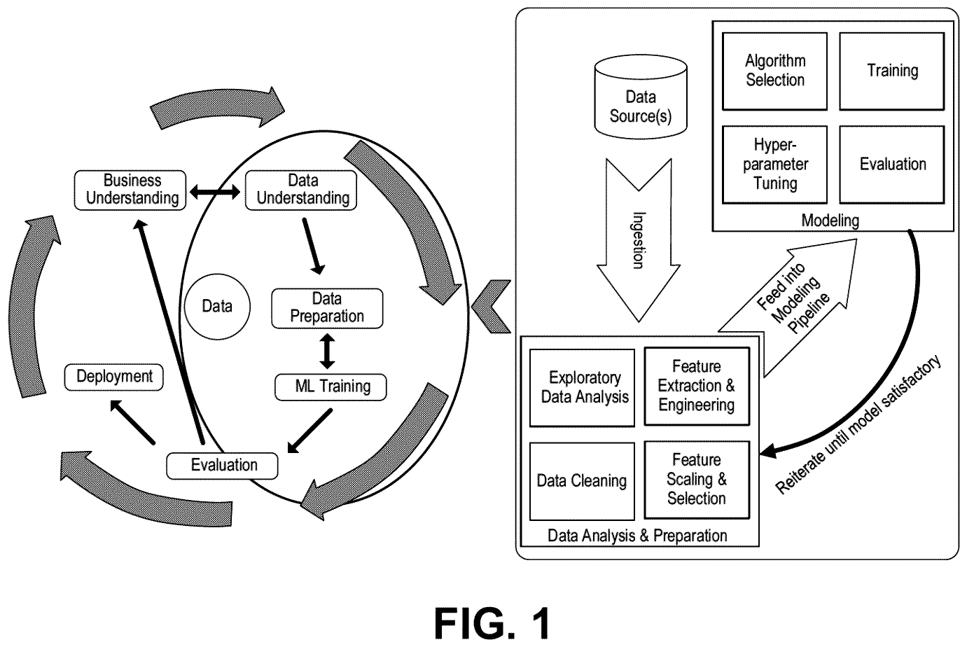

FIG. 2 depicts an overall data preparation flow in an FL system;

FIG. 3 depicts an example EDA response from a single client in JSON format;

FIG. 4 depict an example graphical user interface displaying data preparation resource;

FIG. 5A depicts an example communications system in which the methods and apparatuses described and claimed herein may be an aspect of;

FIG. 5B depicts a block diagram of an example apparatus or device configured for wireless communications;

FIG. 5C depicts a system diagram of an example radio access network (RAN) and core network;

FIG. 5D depicts a system diagram of another example RAN and core network;

FIG. 5E depicts a system diagram of another example RAN and core network;

FIG. 5F depicts a block diagram of an example computing system; and

FIG. 5G depicts a block diagram of another example communications system.

### DETAILED DESCRIPTION OF ILLUSTRATIVE EMBODIMENTS

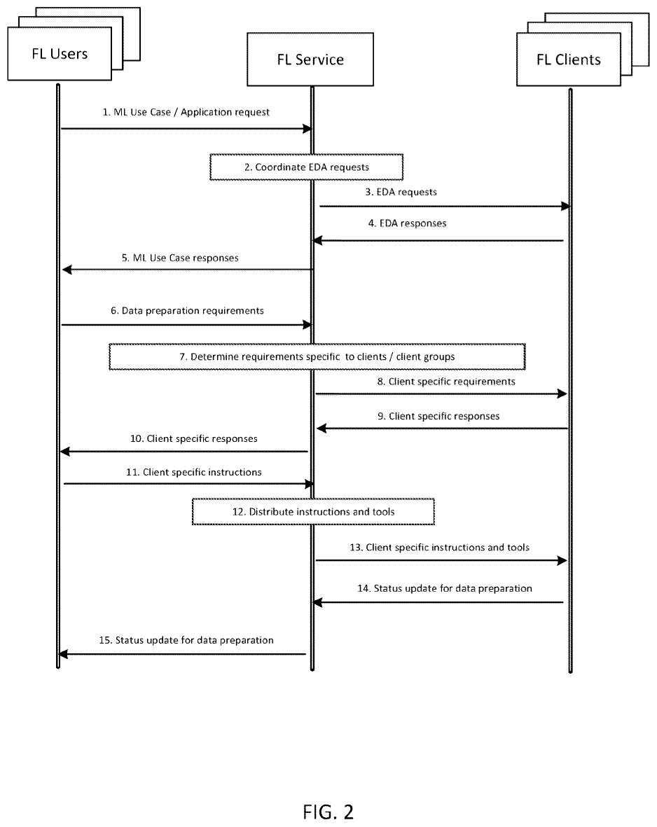

Data preparation for federated learning requires the management and communication of data processing requirements between FL users and FL clients. A FL Service may provide assistance for this management and communication while also performing other FL tasks and operations. FIG. 2 shows a general overview of the proposed progression of events and messages for the management and communication of data processing requirements and the resulting transfer among FL users, the FL service, and FL clients. As a pre-requisite step, the FL clients may have already established communications with the FL service and may have provided basic client capabilities and the available datasets of the clients.

Step 1: An FL user determines the definition and requirements for an ML use case/application (e.g., what to predict, the target and dependent features, the data preparation requirements) and may send a request to an FL service. The request from the FL user may include information as shown in Table 1. The data preparation requirements may be available for well-defined ML use cases and be optional for other, less defined use cases.

TABLE 1
Informational Elements for the ML Use Case Request

| IE | Description |
|---|---|
| FL Identifier | An identifier for the FL use case/application |
| ML use case description | The name of the ML Application and brief description of the |
| | application. |
| Type of ML algorithm-- | The type of machine learning: supervised (regression or |
| General | classification), unsupervised, reinforcement. |
| Type of ML algorithm-- | Specific algorithm to be used: Random Forest, LSTM, CNN, LLM |
| Specific | etc. |
| Target feature | The name of the feature that will be inferenced |
| Mandatory features | A list of mandatory features required for the ML application. |
| Optional features | A list of optional features that may be used in the ML application. |
| | The list of optional features may be used to assist with feature |
| | engineering of mandatory features. |
| Number of features | Specifies the minimum and maximum number of features |
| Data characteristics | For each feature, characteristics of the data that it describes |
| Data preparation | For each feature, the data processing requirements that are |
| requirements | essential to prepare the data for the FL training and/or inference |
| | for well-defined ML use cases. For other ML use cases, this |
| | information may be available after the FL user receives the |
| | aggregated EDA responses from the FL clients. |
| Dataset size | Specifies the size of the dataset; there may be a minimum and a |
| | maximum dataset size. |

Step 2: The FL service may extract the information received from the FL user to identify the required dataset for the ML application. The FL service may extract the information for example by means of a data identification engine using NLP techniques (Keyword Extraction, Named Entity Recognition, etc.) to match the feature requirements for the ML use case (e.g., the target, mandatory, and optional features) with the available datasets on FL clients. There may be an extra iteration wherein the FL service may check with the FL user about the results of the data identification engine (not shown) for a final decision on the datasets to be used for the ML application. This check may comprise the FL service sending one or more messages to the FL user and receiving one or more responses back from the FL user. The message(s) may comprise the determined FL client datasets. The response(s) may comprise an indication whether the FL user agrees on the use of the FL client datasets. Depending on the homogeneity of the FL clients, the FL service may need to identify the appropriate EDA request(s) to send to the different FL clients. Note it can be assumed that the FL service has already identified FL clients that may have datasets available for the type of ML application that the FL user is requesting.

Step 3: The FL service may send the associated one or more FDA requests to the FL clients. The request may include an identifier of the corresponding FL user or an FL identifier. The purpose of the FDA requests can be to query the FL clients to provide statistics of the available data to help determine what data preparation steps may be needed as required for the ML algorithm(s) to be used. An example of the query parameters that the FL service may send to the FL clients are shown in Table 2.

TABLE 2
EDA Queries parameters

| IE/Query | Description |
|---|---|
| FL identifier | An identifier for the FL the EDA query is targeting |
| Dataset Information | |
| >Dataset identifier | An identifier for the dataset |
| >Dataset description(s) | A description of the dataset. |
| >Target feature | Feature to predict |
| >List of features | Independent variables that help build a ML model to predict the target |
| | feature. For instance, the lot size, house size, number of bedrooms, |
| | number of bathrooms etc. would be features to predict the house prices. |
| >ID variables | Identification variables that do not factor with inferencing |
| Data preparation | For well-defined ML use cases, the data preparation requirements may |
| requirements | be known and sent as part of the EDA request. Error! Reference |
| | source not found. provides examples of data preparation requirements |
| | that may be sent. |
| Descriptive Data Statistics | This may be provided for each feature in the dataset |
| >Counts | Total record, total variables, duplicates, missing and unique values per |
| | variable, value counts per variable per value |
| >Numerical summaries | Mean, median, spread (variance, standard deviation, quartiles, |
| | percentiles etc.) |
| >Graphical summaries | Histograms, density plots, box plots, pie plots, pair plots, correlation |
| | matrix |
| >Outliers | Data points that differ significantly from other observations |
| >>Outlier detection | Statistical (parametric, non-parametric), Proximity-based (density, |
| methods | distance, grid, deviation etc.) |
| >>RCA for outliers | Human/experimental/collection/data extraction error, “natural” |
| | (random, data drift, change in system behavior etc.) |

The FL service may send descriptive data statistical functions to each client based on the client capabilities and the available dataset. The FDA requests may entail a package of scripts containing functions performing the queries listed above (accompanied by a separate script to create and activate a virtual environment containing the required packages such as pandas, numpy, etc., to enable the client to perform the FDA task).

The EDA request may also call client-side RESTful APIs and functions to perform the descriptive data statistical queries. An alternative approach can be to implement the EDA requests via CSP data pipeline services. With CSP data pipeline services, the FL user may utilize ready-to-use, drag-and-drop modules with configurable options (e.g., via a GUI) which may also have functionalities to add custom user scripts to the EDA requests.

Alternatively, the entire EDA package may be a runtime executable depending on the operating system of the client.

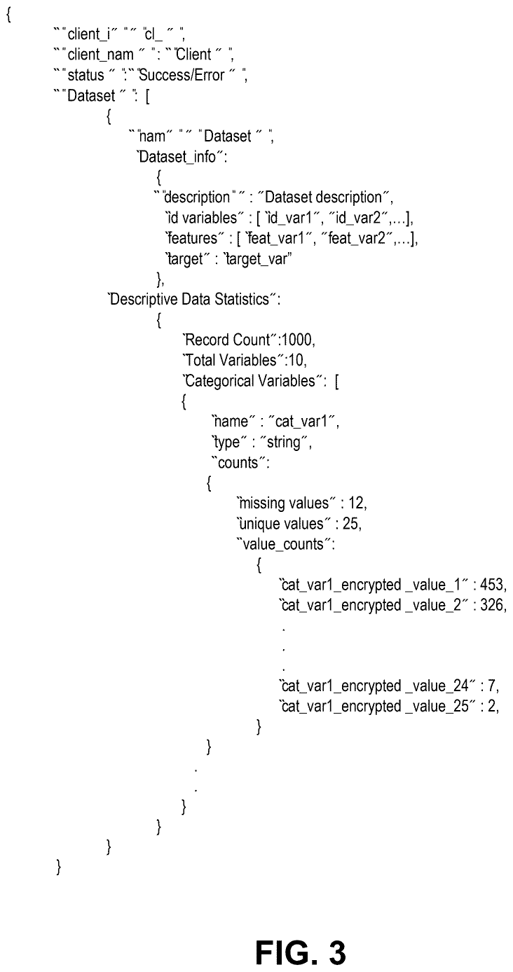

Step 4: FL clients may send responses with the EDA results to the FL service. The responses may include information to the EDA queries as shown in Table 2. The results may include a status to the request and be sent in text files in JSON format, such as the one shown in FIG. 3. For error cases, a more descriptive message may be provided to indicate the errors that were encountered, e.g. one or more error messages received during the EDA execution.

In this step, FL clients may also send any conflicts with the descriptive data statistical requirements should the EDA tasks fail. The FL service may need to repeat step 3 to resolve sending the FL client descriptive data statistical functions that are suitable for the client to use.

Note the information returned to the FL service may be used to generate visual representations (e.g., histograms, tables) for the FL user to understand the data. The returned information may also be used by the FL service to determine FL data preparation requirements.

Step 5: The EDA responses from the FL clients may be aggregated, anonymized, and sent to the FL user. The FL service may maintain a mapping of the anonymized identifiers with the actual FL client identifiers to preserve client privacy. It is also worth noting that prior to sending the combined EDA results to the FL user, the FL service may group FL clients together based on similarities in their EDA responses. This may be achieved through unsupervised ML algorithms (clustering, dimensionality reduction, etc.). Grouping the FL clients together may help in the subsequent step of mapping data preparation requirements to client groups rather than to individual FL clients separately. As an added benefit, interactions with the FL user may be bypassed after the initial round, until a new dataset no longer belongs to a predetermined client group.

Step 6: Data preparation requirements may be sent from the FL user to the FL service based on the EDA results for each FL client or client group. The FL service may allocate specific requirements to specific FL clients/client groups in the subsequent step.

As part of Steps 3, 4, and 5, the results may be consumed by the FL service as input to the customization of data preparation steps for each FL client/client group, via user-configured thresholds and/or rules. For example, binary class imbalances may be regularized such that if one of the two values occurs more than 70% of the time, a SMOTE (Synthetic Minority Oversampling Technique) job may be triggered. As explained in the previous step, this could also be implemented in a harmonized manner such that after receiving the EDA responses from the individual FL clients; the FL service may create groups of FL clients for each of the EDA categories (imbalance, outliers, etc.) and feature combinations which could also help automate the threshold decisions for the data preparation requirements. For example, group boundaries for each feature may also be an input to the process of determining the thresholds for anomalies in different groups.

Table 3 shows a set of data preparation requirements, tools, and/or methods that may be sent to the FL service by the FL user (or made available through CSP data pipeline services), based on the ML use case and data information received from the FL clients. The data preparation requirements may be organized on a per FL client or client group basis, a per feature basis, or a combination of both. Within the feature identifier, one or more data preparation requirements may be specified to indicate what processing functions may be required to process the data.

TABLE 3
Data Preparation Requirements

| Method | Description |
|---|---|
| Anonymized | The anonymized FL client identifier that the data preparation |
| Client/Group ID | requirements/methods/tools apply to. The FL service had provided this |
| | identifier to associate the EDA responses with the appropriate FL |
| | client. For cases in which clients are grouped together (e.g., due to |
| | similar EDA responses), the ID may be a group ID that the FL service |
| | may have created to represent the group of clients. |
| Dataset identifier | An identifier for the dataset |
| Feature identifier | Associated with a feature of the dataset and the desired data preparation |
| | requirements |
| >Standardized data | Units, variable format (numerical, string, etc.) |
| formatting | |
| >Missing Values | Remove, fill in (average/most common value, neighbor, ML) |
| >Handling outliers | Act based on RCA |
| >Handling data | Oversampling, under sampling. |
| imbalances | |
| >Feature Engineering | Encoding of categorical values, scaling, mathematical transformations, |
| | split/combine |
| >Feature Selection | |
| >>Filter methods | Information Gain, Chi-square Test, Fisher's Score, Correlation |
| | Coefficient etc. |
| >>Wrapper methods | Forward Feature Selection, Backward Feature Elimination, Exhaustive |
| | Feature Selection, Recursive Feature Elimination etc. |
| >>Embedded methods | LASSO Regularization, Random Forest Importance, etc. |

Step 7: In this step, the FL service may identify data preparation requirements specific to FL clients or client groups based on the mapping of the anonymized identifier with the actual identifier. The mapping of requirements to the type of EDA results may have been determined in a previous step. In this step, the FL service may allocate the requirements to the specific FL client/client group. The data preparation requirements may exist in the form of functions that the FL user and/or FL service provides to the FL clients. Additionally, and/or alternatively, the FL service may map the data preparation requirements to data functions.

TABLE 4
Client and Data Preparation Groups based on EDA Results and associated needs.

| IE | Description |
|---|---|
| Clients | A list of Client IDs |
| Client Groups | Client groups based on groupings of EDA results |
| Dataset identifier | An identifier for the dataset |
| Feature identifiers | Identifiers of the features impacted by data preparation requirement |
| Set of EDA results | Groupings of EDA results based on similarities that may require the same |
| | data preparation functions. |
| Set of Data | Data Preparation Requirements for all clients based on EDA groups. One of |
| Preparation | more data preparation requirements may be specified for each feature. |
| Requirements | |

Step 8: Messages containing FL client or client group specific data preparation instructions based on requirements determined in the previous step may be sent from the FL service to the FL clients in this step. Similar to the EDA requests, these messages may comprise packages of scripts containing relevant functions, invoking client-side API functions, or runtime executables. Additionally, and/or alternatively, the scripts may be calling user-configured CSP data pipeline services. The modules in such services may be of no-code type and/or ones the FL user may insert custom scripts into.

Step 9: Client specific feedback regarding data preparation capabilities and needs (package/framework dependencies including versions, availability of specific functional API, computational capabilities) may be sent to the FL service. The response from the FL client may include information as shown in Table 5.

TABLE 5
Client and Data Preparation Needs from Clients

| IE | Description |
|---|---|
| Client ID | Client identifier |
| Status | The status to the request |
| Dataset identifier | An identifier for the dataset |
| Feature identifiers | Identifiers of the features impacted by data preparation requirement |
| Required Functions | Data preparation functionalities not accessible by the client |
| Data preparation | Data preparation capabilities that can be provided or supported by the client. |
| capabilities | |

Step 10: Client specific responses for data preparation needs may be aggregated and sent from the FL service to the FL user as shown in Table 6. Similar to the EDA responses, groupings of needs and tools may be established which may help equip the FL clients in need by the FL service automatically, without the intervention by the FL user. In addition, the FL service may anonymize the FL client identifiers to preserve client privacy.

TABLE 6
Data Preparation Needs and Tools

| IE | Description |
|---|---|
| Anonymized | Anonymized client/group identifier |
| Client/Group ID | |
| Status | The status to the request |
| Dataset identifier | An identifier for the dataset |
| Feature identifiers | Identifiers of the features impacted by data preparation requirement |
| Required Functions | Data preparation functionalities not accessible by the client |
| Data preparation | Data preparation capabilities that can be provided or supported by the client. |
| capabilities | |

Step 11: Client/Client group specific instructions and tools may be sent to the FL service by the FL User. The instructions and tools may include the functionalities required by the FL clients as indicated in “Required Functions” in Table 5 and Table 6. The specific instructions may be provided to address any issues and/or errors encountered by the FL client/client group to fulfill the data preparation requirements. Note that multiple iterations may be performed to resolve complex issues and/or errors.

Step 12: In this step, the FL service may coordinate specific instructions and tools to FL clients/client groups. The FL service may perform mapping of the anonymized client/client group identifiers to the actual FL client identifiers to distribute the instructions and tools.

Step 13: Client specific instructions and tools may be sent to the FL clients to make them capable of implementing the data processing steps necessary to train the ML model using the local data of each client or exclude the client from the FL service if the data preparation task is not feasible. Similar to step 11, the FL service may have multiple interactions with the FL clients to resolve complex issues and/or errors.

Step 14: In this step, the status of the data preparation steps may be sent from the FL clients to the FL service (e.g., success/error).

Step 15: The FL service may aggregate the status message from the FL clients and send the aggregated message to the FL user using the anonymized client/client group identifiers.

After step 15 completes, steps 11 to 15 may be repeated as needed, such as sending new and/or updated instructions and tools to the FL clients based on the status of data preparation.

The description associated with FIG. 2 shows an example of the communication and management required for a FL user to communicate data preparation requirements to FL clients with the assistance of the FL service. Thus far, it has been assumed that requests and responses shown in FIG. 2 have been sent and received successfully and without error. If an FL client encounters an issue with completing any of the tasks in the general flow of FIG. 2, the messages the client may send to the FL service may include corresponding error messages generated upon attempting the task. Those error messages may be sent to the FL user for manual intervention or used by the FL service to identify the nature of the issue through a rule-based, or NLP engine.

For example, if an EDA or data preparation method is not available at the FL client in steps 4 and 9 of FIG. 2, the FL client may return a response indicating the unavailable method to the FL service, which may then informed the FL user. In response, the FL user may request the FL service to provide instructions for downloading the required package(s). Additionally and/or alternatively, there may exists predetermined sets of rules in the FL service (an error-to-resolution mapping) which may be triggered to download the requirements. If a certain function requires a variable/feature to be in a particular data type, such requirement may be recognized from the error message and the right variable transformation may be instructed to the FL client to perform. This may be done by the FL user (via the FL service) or by the FL service automatically. Similar to the EDA capabilities and/or data preparation functions, such transformations may be available as part of a client API, as a CSP service, may be manually coded by the FL user, or via automatically triggered pre-written scripts.

Another source of issue may be insufficient computational capabilities of the FL client, which the client may indicate in responses to steps 4, 9, and 14 of FIG. 2. In this case the FL user may decide to exclude the FL client from training the ML model in a federated manner. Alternatively, a containerized compute resource may be made available by the CSP to complete the task, which may then be deallocated upon producing the aggregated EDA results or completing the data preparation tasks.

Communication may be another area where errors may be encountered. There may be a number of attempts beyond which the FL task may be deemed “failed”, or “on-hold” in which case another round of attempts may be made after a preset period. If a client is no longer in the FL system/network due to network issues, firmware/system updates or a possible reboot, the FL service may receive a corresponding signal, interpret it appropriately (rule-based, NLP etc.) and inform the FL user. There may be a manual intervention by the FL user and/or a set of automated actions by the FL service for further steps. The communication errors may be reported to the FL user in responses sent by the FL service, which may either receive responses from the FL clients indicating the error or by automatic detection by the service due to timer expiration and/or FL client unresponsiveness.

Client specific data preparation instructions provided by the FL user in step 11 of FIG. 2 may inform the FL clients on how to process the data in order to prepare the dataset for federated learning. Each FL client or client group may require different data preparation functions depending on the client responses that were provided to the FL user in steps 5 and 10. The following descriptions describe some of the data preparation instructions that the FL user may send to the FL service to distribute to the FL clients and/or client groups.

Depending on whether the data is numerical or categorical, different data preparation methods may be requested by the FL user (via the FL service) or by the FL service. One or more of the following EDA methods may be used by the FL user and/or FL service to determine the data preparation methods required for numerical features: Descriptive data statistics: Counts: Total, duplicates, missing counts, unique values (may still be important if a given numerical variable is sparsely distributed); Numerical: Mean, median, spread (variance, standard deviation, quartiles, percentiles etc.); Graphical; Histograms, density plots: To show the distribution of value counts per values (or value intervals/bins); Box plots: Again useful for distribution, focusing on the spread; Pair plots: Scatter plots of pairs of numerical variables: Correlation matrix: Shows paired correlation values of numerical features. (These values are basically «summaries of pair» plots). These basically show the variability of the feature(s) affects the variability of the target variable, or other features. For example, if the sales price of the house in the historical data does not vary a lot with the lot size (which is not a realistic scenario), the lot size may be dropped from the ML model to predict house prices. But it also helps possible collinearity cases wherein two or more features are linearly dependent on each other due to possibly a causal relationship. For instance, if the dataset contains numbers of steps and distance in miles of people's walking, there will be a clear collinearity, which will show in the correlation matrix between these two variables; Anomalies: There may be preset thresholds such as 2 standard deviations from the mean to define the anomalies. Alternatively, an adaptive approach may be followed based on densities, or distances etc.: Understanding data types: Often, numerical features may be represented or acquired as string in which case the corresponding first data preparation step may be converting the data field to numerical.

Using the insights acquired from the EDA responses (e.g. the descriptive data statistics) from step 5 of FIG. 2, the FL user may determine data preparation requirements for each FL client or client group.

Numerical data may be further categorized into two types: discrete and continuous. For example, the salary of an employee may be continuous data and the age of a person and the number of houses owned by a person may be discrete data. Some numerical data preparation methods requested by a FL user (via the FL service) and/or the FL service are as follows: Similar to the categorical features, missing values may either be entirely omitted (rows/columns), or imputed using “arbitrary” values, which is also called “Random Sample Imputation”; Unique to numerical features, missing values may also be imputed using mean or median values of the numerical feature. There may also be dedicated ML models using other features in the data to “predict” the missing values of a given numerical features: Especially in time series data, replacing with previous value, or forward fill may be another method; Once determined in the EDA steps, anomalies and data imbalances may be handled using similar approaches to categorical features; Feature scaling/normalization may also be used to normalize the range of independent variables or features of data. Several different methods to normalize features may be used such as one or more of the following: Rescaling (min-max normalization) and Standardization (z-score normalization); Rank transformation of non-tree based models; Log transformation to reduce the variability of data

Some categorical data preparation methods requested by a FL user (via the FL service) and/or the FL service are as follows: Categorical data is used for information that only has a few possible values, such as single family or multi-family homes in a house dataset. A FL user (via a FL service) and/or FL service may request data preparation of a categorical feature/variable operations/queries such as: Total counts; Missing value counts; Unique value counts; Counts of records per unique value (a histogram, for instance, may also show this information); Realizing extremely rare values (or anomalies); Understanding data types: Most of the time the categorical data may occur in some sort of non-numeric type in the dataset (such as ‘object’ in pandas library of Python); Using groupby functionality or pivot tables to group data by unique values of categorical variables and apply aggregate functions to observe how statistics (such as sum, mean, and count) of numerical variables vary; Creating cross-tabulation tables to show the frequency distribution of two or more categorical variables. This function is useful when you want to see the relationship between two or more categorical variables, such as how the frequency of one variable is related to another variable; How the variability of the feature(s) affects the variability of the target variable. For example, if houses have different colors, how does the color affect the sales price of the house in the historical data? If it doesn't, it may be beneficial to drop the color feature from a model that may predict house prices. This is analogous to the correlation of a numerical target variable to a numerical feature.

Missing data may be defined as the values or data that is not stored (or not present) for some variable(s) in the given dataset. It could be entire rows, columns, or some values of some variables. It may be represented as blank records, or values such as ‘NaN’. There may be multiple reasons for the missing data such as data corruption, some observations not being recorded (system and/or human related), intentional omission, nonresponse.

Unique values and their counts for categorical variables are important to know the variability and how balance/imbalance in the distribution of that feature. For instance, four categories for age ranges such as ‘Children’ (1-12), ‘Adolescents’ (13-17), ‘Adults’ (18-75), ‘Older Adults’ (75 and older) may be available in a demographic's dataset. If there's an overrepresentation of one age group in the data, such as the ‘Older Adults’ comprising 75% of the data records, this may constitute an imbalance in the age range feature.

It is also often important to know how the rest of the data is “distributed” among the unique values categorical variables. Continuing the above age group example, the FL user may be interested to know the income level statistics for different age groups (or even in subgroups among these groups such as gender). Grouping the data by the unique values as well as creating cross-tabulation tables gives the FL user the ability to have these insights. After these insights are gained, the FL user may “decide” on client specific data preparation actions. Below are some sample data preparation actions.

Entire rows or columns with missing values may be deleted, based on similar criteria, or replaced with an arbitrary value. The FL user may also choose to replace missing values with the mostly encountered value for that feature in the dataset. This is analogous to replacing a numerical missing value with the mean of that feature.

Groups in the feature space may be formed to “predict” the missing values. For instance, if the data for a house is missing the number of bathrooms, and it has 5 bedrooms and 3 floors, a separate ML model may be built that would use other houses' data with similar numbers of bedrooms and floors (and other “similar” features) to impute the missing value for the number of bathrooms.

Anomalies may also be handled based on other features' values. For instance, if the other features' groupings correspond to a more “regular” value for the given feature with the anomalous/rare value in question, there may have been an error (human/system) in recording the value, in which case the value may be rectified to the “regular” value, or the corresponding data record (corresponding to an entire row in a tabular data) may entirely be excluded. On the other hand, the new, rare value may indicate a change in the system response/behavior, which may be understood by a “wait and see” approach as well.

Datasets in domains like, fraud detection in banking, real-time bidding in marketing, disease treatment in healthcare or intrusion or failure detection in networks/systems, have one thing in common. The data used in these areas often have less than 1% of rare, but “interesting” events (e.g. fraudsters using credit cards, user clicking advertisement, corrupted server scanning its network or percentage of the entire population infected by a given disease). However, most machine learning algorithms do not work very well with imbalanced datasets. There are techniques, however that may help train a classifier to detect the abnormal class. And some of those techniques are related to data preparation: Under-sampling aims to balance the dataset by reducing the size of the abundant class. This method is used when quantity of data is sufficient. By keeping all samples in the rare class and randomly selecting an equal number of samples in the abundant class, a balanced new dataset may be retrieved for further modelling. An elegant approach is also clustering the abundant class in k groups, with k being the number of cases. For each group, only the medoid (center of the cluster) is kept. The model is then trained with the rare class and the medoids only.

Oversampling, on the other hand, has the objective to increase the proportion of the rare class value in the data. Especially when the quantity of the overall data is insufficient. In this approach, the dataset may be balanced by increasing the size of rare samples, by generating new rare samples through various techniques such as repetition, bootstrapping or SMOTE.

The FL user or FL service may use predetermined rules for handling imbalances in the following way: If the “rare” class represents less than 50% of the 100%/number of unique values in the entire data, use SMOTE. This would mean the following. Say, there are 4 unique values of a given category in the dataset. A uniform distribution would mean each category value would be represented by 100%/4=25% of the dataset. If however a given category value is only represented in 10% of the dataset, then the FL user may decide to use oversampling, or set a rule to do so.

Encoding, including ordinal encoding and nominal encoding, may include the following: Label Encoding may be used to transform the target variable to numbers where each label/class is represented by unique number. It is kind of similar to ordinal encoding however these numbers can't be ranked/ordered.

Target encoding may be used which is a Bayesian encoding method in which the mean of the target variable for each category is calculated which then replaces the category variable with the mean value. In the case of the categorical target variables, the posterior probability of the target replaces each category. Target encoding may be performed for training data only and the test data will be coded using results obtained from the training dataset.

One-hot encoding may be used in which anew set of dummy (binary) variables is created that is equal to the number of categories (k) in the variable. For example, a categorical variable Color has three categories called “Red”, “Green” and “Blue”, three dummy variables are needed to encode this variable using one-hot encoding. A dummy (binary) variable just takes the value 0 or 1 to indicate the exclusion or inclusion of a category.

Dummy encoding may be used which also uses dummy (binary) variables. Instead of creating a number of dummy variables that is equal to the number of categories (k) in the variable, dummy encoding uses k−1 dummy variables. To encode the same Color variable with three categories using the dummy encoding, only two dummy variables are needed.

Hash encoding may be used, but may be lossy, and “collision” is an issue.

Binary encoding may be used which is a combination of one-hot and hash encodings. In this encoding scheme, the categorical feature is first converted into numerical using an ordinal encoder. Then the numbers are transformed in the binary number. After that binary value is split into different columns. Binary encoding works well when there are a high number of categories. For example the cities in a country where a company supplies its products.

Base N encoding may be used which is a superset of binary encoding, where instead of using base 2 for encoding, the base is specified as an integer N for which the encoding is performed against.

The above descriptions provide examples of data preparation requirements that may be requested by FL users. The FL service may communicate the data preparation requirements to the FL clients to ensure the datasets of the different FL clients meet the requirements for training the ML application that the FL user is interested. The FL service may also manage the FL clients when issues may arise or errors are encountered.

### EXAMPLE

One of the approaches to realize the aforementioned FL service data preparation functionality is through a RESTful API supported by a FL service. The RESTful API may comprise one or more different types of resources hosted and stored by the FL service which are accessed by FL clients and FL users via RESTful operations commonly referred to as methods (e.g., PUT, POST, GET, DELETE). Each type of resource defined for the API may comprise a defined set of information elements commonly referred to as attributes. These resource types and their respective attributes provide a means for the FL service to receive information from FL clients and FL users using RESTful protocols such as HTTP, process the information by performing FL service specific tasks, and provide results of these operations back to the FL clients and FL users. Hence the RESTful APIs are used by FL clients and FL users to interface with the FL service and access the supported capabilities of the FL service in a RESTful manner. In the subsequent sections, some examples of FL service API resource types and their specific attributes are defined.

The aforementioned set of methods and procedures for Exploratory Data Analysis may by realized via data preparation resource(s) supported by a RESTful API of the FL service. A data preparation resource may comprise attributes as shown in the example in Table 7. Alternatively, the information shown in Table 7 may be split across one or more additional types of resources supported by the FL service API. The types of attributes supported by a data preparation resource may comprise one or more of the aforementioned types of information elements such as but not limited to those defined in Tables 1-6. Note that Table 7 shows one example of how attributes may be organized within the FL service but other approaches to organize the attributes may be envisioned.

TABLE 7
Data Preparation Resource of FL Service

| Attribute | Description |
|---|---|
| FL Use Case Information: | |
| >FL Identifier | An identifier for the FL use case/application |
| >ML use case description | The name of the ML Application and brief description of the |
| | application. |
| >Type of ML algorithm-- | The type of machine learning: supervised (regression or |
| General | classification), unsupervised, reinforcement. |
| >Type of ML algorithm-- | Specific algorithm to be used: Random Forest, LSTM, CNN, |
| Specific | LLM etc. |
| >Target feature | The name of the feature that will be inferenced |
| >Mandatory features | A list of mandatory features required for the ML application. |
| >Optional features | A list of optional features that may be used in the ML |
| | application. The list of features may be used to assist with |
| | feature engineering of mandatory features. |
| >Number of features | Specifies the minimum and maximum number of features |
| >Data characteristics | For each feature, characteristics of the data that it describes |
| >Data preparation | For each feature, the data processing requirements that are |
| requirements | essential to prepare the data for the FL training and/or inference |
| | for well-defined ML use cases. For other ML use cases, this |
| | information may be available after the FL user receives the |
| | aggregated EDA responses from the FL clients. |
| >Dataset size | Specifies the size of the dataset; there may be a minimum and a |
| | maximum dataset size. |
| Dataset Information: | |
| >Client identifier | An identifier for the FL client |
| >Dataset identifier | An identifier for the dataset |
| >Dataset description(s) | A description of the dataset. |
| >Target feature | Feature to predict |
| >List of features | Independent variables that help build a ML model to predict the |
| | target feature. For instance, the lot size, house size, number of |
| | bedrooms, number of bathrooms etc. would be features to predict |
| | the house prices. |
| >ID variables | Identification variables that do not factor with inferencing |
| Data preparation | For well-defined ML use cases, the data preparation |
| requirements | requirements may be known and sent as part of the EDA request. |
| | Error! Reference source not found. provides examples of data |
| | preparation requirements that may be sent. |
| Descriptive Data Statistics: | |
| >Client identifier | An identifier for the FL client |
| > Counts | Total record, total variables, duplicates, missing and unique |
| | values per variable, value counts per variable per value |
| > Numerical summaries | Mean, median, spread (variance, standard deviation, quartiles, |
| | percentiles etc.) |
| > Graphical summaries | Histograms, density plots, box plots, pie plots, pair plots, |
| | correlation matrix |
| > Outliers | Data points that differ significantly from other observations |
| >>Outlier detection methods | Statistical (parametric, non-parametric), Proximity-based |
| | (density, distance, grid, deviation etc.) |
| >>RCA for outliers | Human/experimental/collection/data extraction error, “natural” |
| | (random, data drift, change in system behavior etc.) |
| FL User Data Preparation | |
| Requirements: | |
| >Anonymized Client/Group | The anonymized FL client identifier that the data preparation |
| ID | methods/tools apply to. The FL service had provided this |
| | identifier to associate the EDA responses with the appropriate FL |
| | client. For cases in which clients are grouped together (e.g., due |
| | to similar EDA responses), the ID would be a group ID that the |
| | FL service may have created to represent the group of clients. |
| >Dataset identifier | An identifier for the dataset |
| >Feature identifier: | Associated with a feature of the dataset and the desired data |
| | preparation requirements |
| >>Standardized data | Units, variable format (numerical, string, etc.) |
| formatting | |
| >>Missing Values | Remove, fill in (average/most common value, neighbor, ML) |
| >>Handling outliers | Act based on RCA |
| >>Handling data imbalances | Oversampling, under sampling. |
| >>Feature Engineering | Encoding of categorical values. scaling, mathematical |
| | transformations, split/combine |
| >>Feature Selection: | |
| >>>Filter methods | Information Gain, Chi-square Test, Fisher's Score, Correlation |
| | Coefficient etc. |
| >>>Wrapper methods | Forward Feature Selection, Backward Feature Elimination, |
| | Exhaustive Feature Selection, Recursive Feature Elimination etc. |
| >>>Embedded methods | LASSO Regularization, Random Forest Importance, etc. |
| FL Client Data Preparation | |
| Information: | |
| >Client Identifiers | A list of Client IDs |
| >Client Groups | Client groups based on groupings of EDA results |
| >Dataset identifier | An identifier for the dataset |
| >Set of EDA results | Groupings of EDA results based on similarities that may require |
| | the same data preparation functions. |
| >Set of Data Preparation | Data Preparation Requirements for all clients based on EDA |
| Requirements | groups. One of more data preparation requirements may be |
| | specified for each feature. |
| >Required Functions | Data preparation functionalities not accessible by the client |

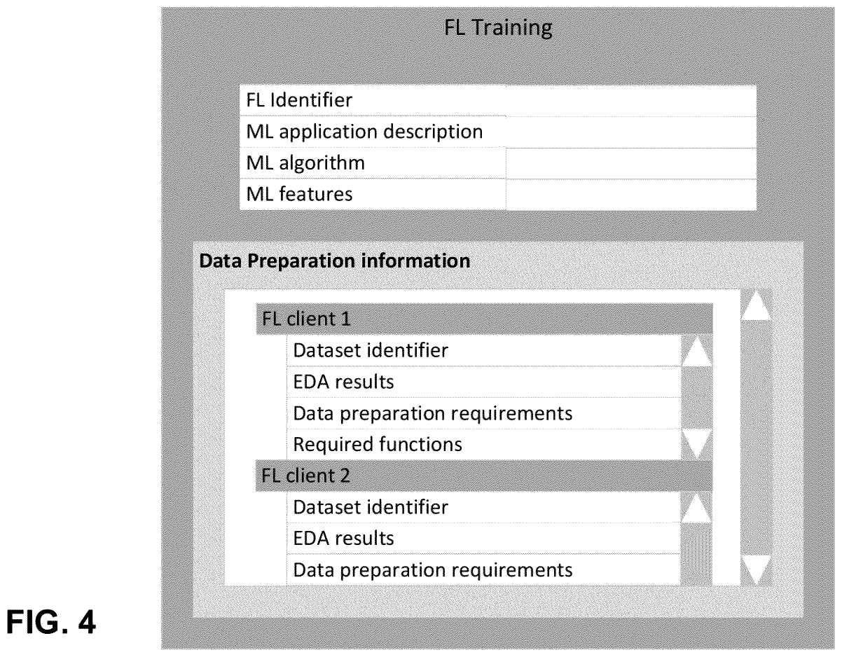

The information shown in Table 7 may be displayed in an example GUI as shown in FIG. 4. The GUI may be provided by the FL service to display all the information captured in Table 7 to the FL user to provide information of the management and configuration of data preparation requirements to the FL clients. A FL user may interact with the FL service via this GUI to perform the aforementioned operations defined in this invention. For example, a FL user may configure the FL service and receive status information back from the FL service via this GUI.

### Example Communications System

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 7 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I). Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

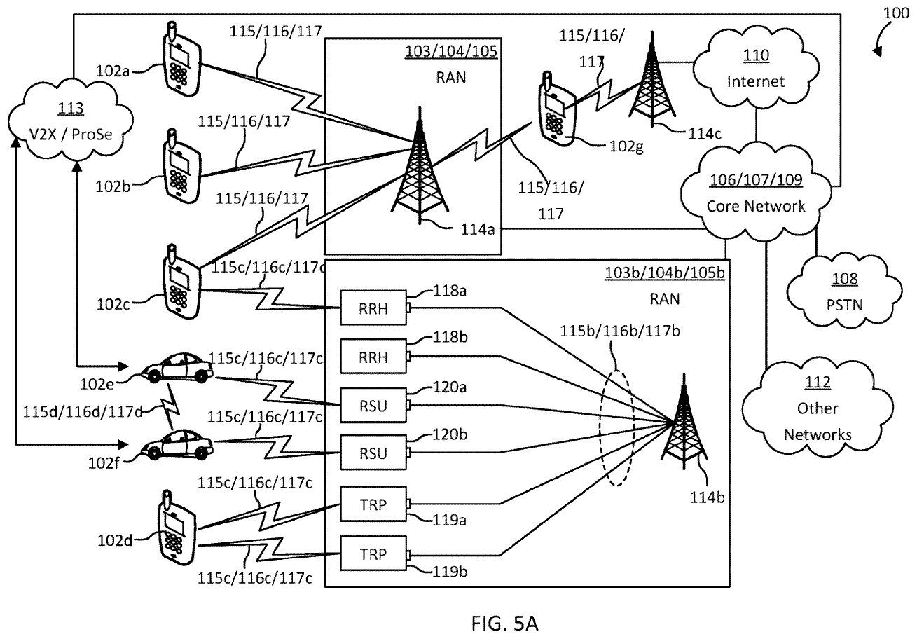

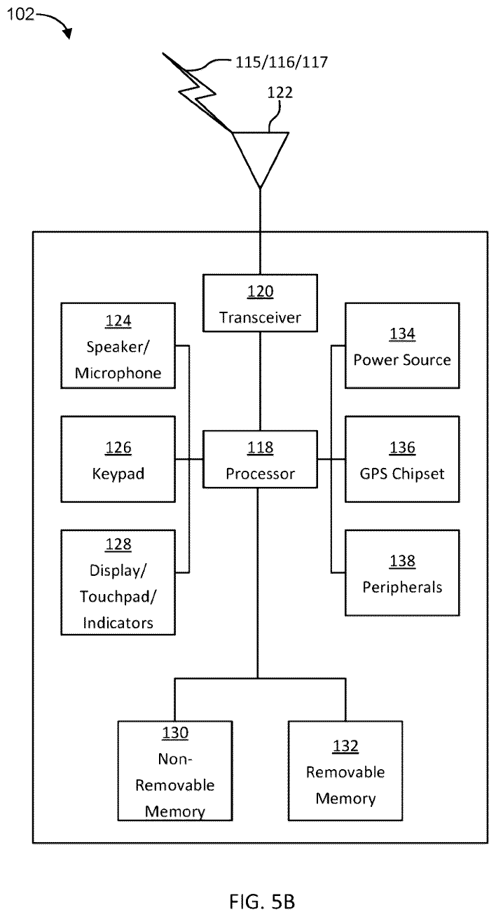

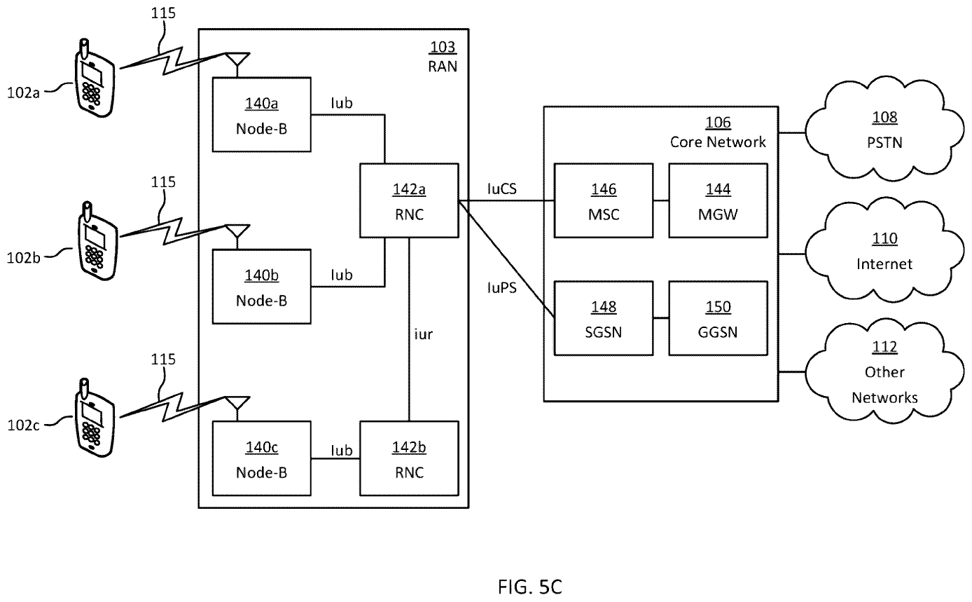

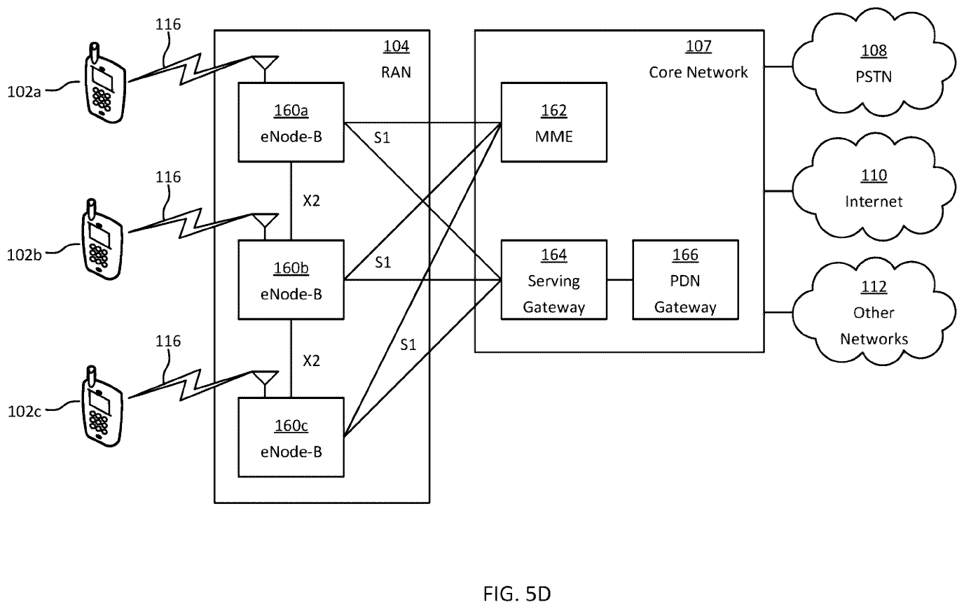

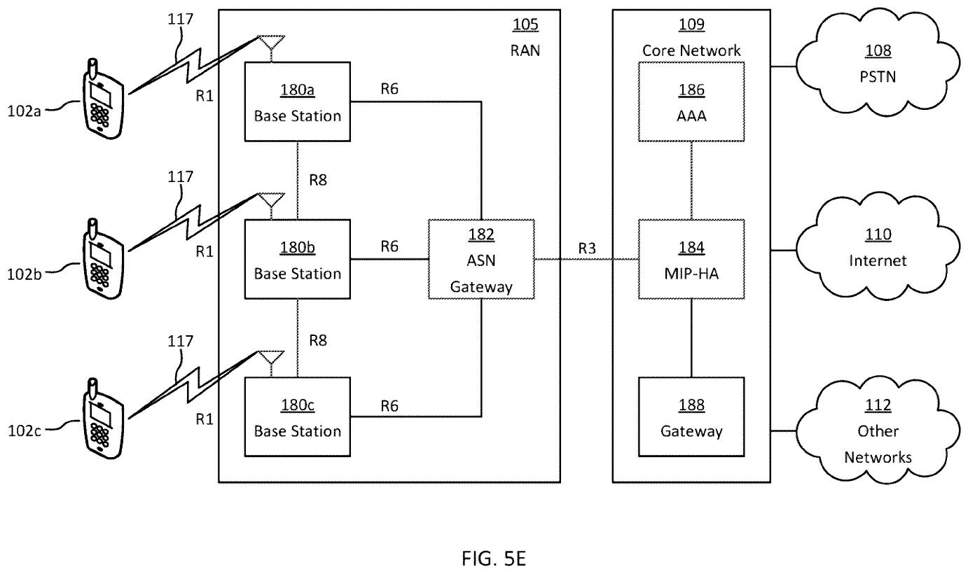

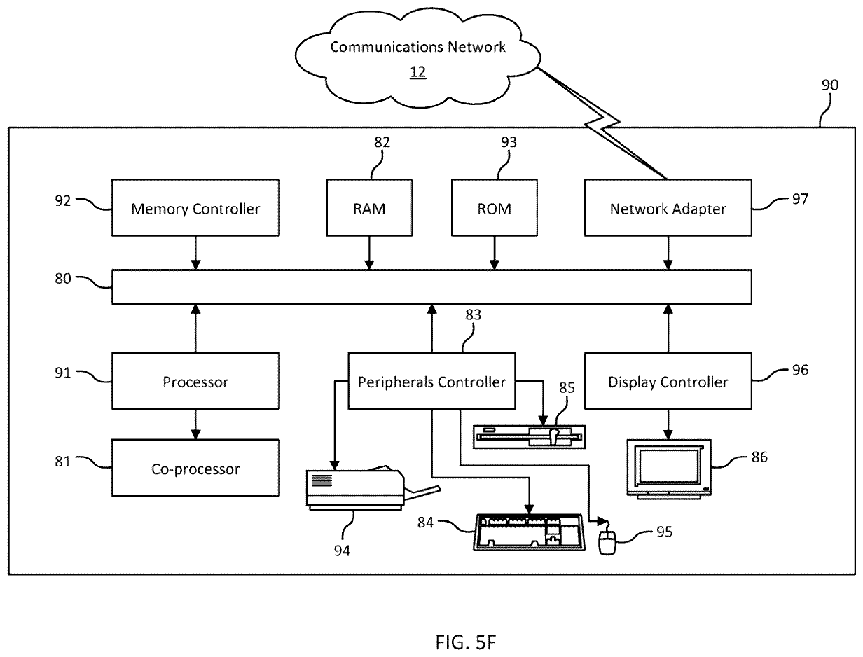

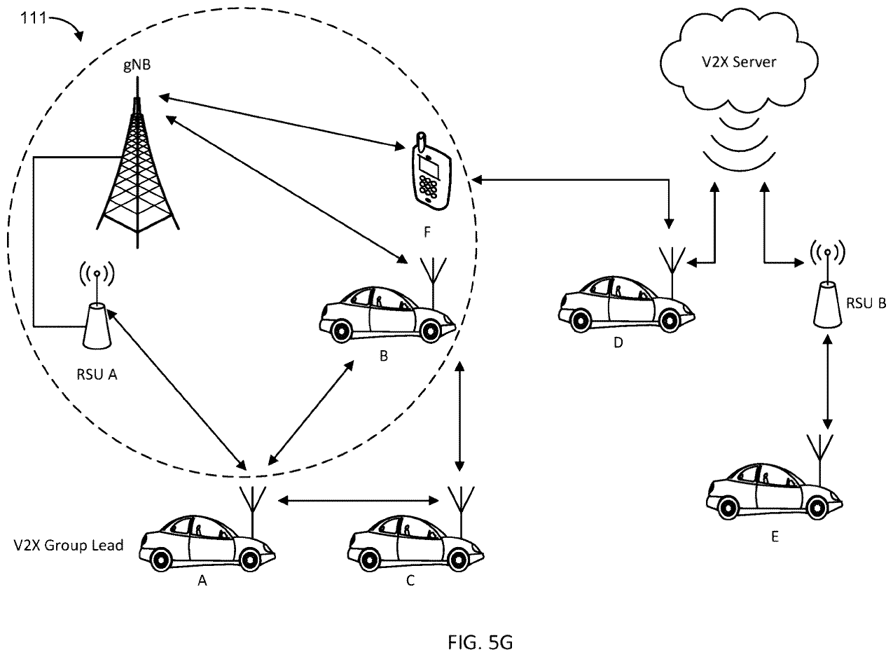

FIG. 5A illustrates an example communications system 100 in which the methods and apparatuses described and claimed herein may be an aspect of. As shown, the example communications system 100 may include wireless transmit/receive units (WTRUs) 102a, 102b, 102c, 102d, 102e, 102f, and/or 102g (which generally or collectively may be referred to as WTRU 102), a radio access network (RAN) 103/104/105/103b/104b/108B, a core network 106/107/109, a public switched telephone network (PSTN) 108, the Internet 110, other networks 112, and V2X server (or ProSe function and server) 113, though it will be appreciated that the disclosed examples contemplate any number of WTRUs, base stations, networks, and/or network elements. Each of the WTRUs 102a, 102b, 102c, 102d, 102e, 102f, 102g may be any type of apparatus or device configured to operate and/or communicate in a wireless environment. Although each WTRU 102a, 102b, 102c, 102d, 102e, 102f, 102g is depicted in FIGS. 5A-5E as a hand-held wireless communications apparatus, it is understood that with the wide variety of use cases contemplated for 5G wireless communications, each WTRU may comprise or be embodied in any type of apparatus or device configured to transmit and/or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, truck, train, or airplane, and the like.

The communications system 100 may also include a base station 114a and a base station 114b. Base stations 114a may be any type of device configured to wirelessly interface with at least one of the WTRUs 102a, 102b, 102c to facilitate access to one or more communication networks, such as the core network 106/107/109, the Internet 110, and/or the other networks 112. Base stations 114b may be any type of device configured to wiredly and/or wirelessly interface with at least one of the RRHs (Remote Radio Heads) 118a, 118b, TRPs (Transmission and Reception Points) 119a, 119b, and/or RSUs (Roadside Units) 120a and 120b to facilitate access to one or more communication networks, such as the core network 106/107/109, the Internet 110, the other networks 112, and/or V2X server (or ProSe function and server) 113. RRHs 118a, 118b may be any type of device configured to wirelessly interface with at least one of the WTRU 102c, to facilitate access to one or more communication networks, such as the core network 106/107/109, the Internet 110, and/or the other networks 112. TRPs 119a, 119b may be any type of device configured to wirelessly interface with at least one of the WTRU 102d, to facilitate access to one or more communication networks, such as the core network 106/107/109, the Internet 110, and/or the other networks 112. RSUs 120a and 120b may be any type of device configured to wirelessly interface with at least one of the WTRU 102e or 102f, to facilitate access to one or more communication networks, such as the core network 106/107/109, the Internet 110, the other networks 112, and/or V2X server (or ProSe function and server) 113. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114b may be part of the RAN 103b/104b/105b, which may also include other base stations and/or network elements (not shown), such as a base station controller (BSC), a radio network controller (RNC), relay nodes, etc. The base station 114a may be configured to transmit and/or receive wireless signals within a particular geographic region, which may be referred to as a cell (not shown). The base station 114b may be configured to transmit and/or receive wired and/or wireless signals within a particular geographic region, which may be referred to as a cell (not shown). The cell may further be divided into cell sectors. For example, the cell associated with the base station 114a may be divided into three sectors. Thus, the base station 114a may include three transceivers, e.g., one for each sector of the cell. In some cases, the base station 114a may employ multiple-input multiple output (MIMO) technology and, therefore, may utilize multiple transceivers for each sector of the cell.

The base stations 114a may communicate with one or more of the WTRUs 102a, 102b, 102c over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, and/or RSUs 120a and 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 118B/116b/117b may be established using any suitable radio access technology (RAT).

The RRHs 118a, 118b, TRPs 119a, 119b and/or RSUs 120a, 120b, may communicate with one or more of the WTRUs 102c, 102d, 102e, 102f over an air interface 118C/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c,102d, 102e, 102f, and/or 102g may communicate with one another over an air interface 115d/116d/117d (not shown in the figures), which may be any suitable wireless communication link (e.g., radio frequency (RF), microwave, infrared (IR), ultraviolet (UV), visible light, cmWave, mmWave, etc.). The air interface 118D/116d/117d may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a. 118b,TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In some cases, the base station 114a and the WTRUs 102a, 102b, 102c, or RRHs 118a, 118b, TRPs 119a, 119b, and/or RSUs 120a, 120b, in the RAN 103b/104b/108B and the WTRUs 102c, 102d, may implement a radio technology such as Evolved UMTS Terrestrial Radio Access (E-UTRA), which may establish the air interface 115/116/117 or 118C/116c/117c respectively using Long Term Evolution (LTE) and/or LTE-Advanced (LTE-A). In the future, the air interface 115/116/117 may implement 3GPP NR technology. The LTE and LTE-A technology includes LTE D2D and V2X technologies and interface (such as Sidelink communications, etc.) The 3GPP NR technology includes NR V2X technologies and interface (such as Sidelink communications, etc.)

In some cases, the base station 114a in the RAN 103/104/105 and the WTRUs 102a, 102b, 102c, or RRHs 118a, 118b, TRPs 119a, 119b and/or RSUs 120a, 120b, in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000). Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 5A may be a wireless router, Home Node B, Home eNode B. or access point, for example, and may utilize any suitable RAT for facilitating wireless connectivity in a localized area, such as a place of business, a home, a vehicle, a campus, and the like. In some cases, the base station 114c and the WTRUs 102e, may implement a radio technology such as IEEE 802.11 to establish a wireless local area network (WLAN). In some cases, the base station 114c and the WTRUs 102d, may implement a radio technology such as IEEE 802.15 to establish a wireless personal area network (WPAN). In some cases, the base station 114c and the WTRUs 102e, may utilize a cellular-based RAT (e.g., WCDMA, CDMA2000, GSM, LTE, LTE-A, etc.) to establish a picocell or femtocell. As shown in FIG. 5A, the base station 114b may have a direct connection to the Internet 110. Thus, the base station 114c may not be required to access the Internet 110 via the core network 106/107/109.

The RAN 103/104/105 and/or RAN 103b/104b/105b may be in communication with the core network 106/107/109, which may be any type of network configured to provide voice, data, applications, and/or voice over internet protocol (VoIP) services to one or more of the WTRUs 102a. 102b, 102c, 102d. For example, the core network 106/107/109 may provide call control, billing services, mobile location-based services, pre-paid calling. Internet connectivity, video distribution, etc., and/or perform high-level security functions, such as user authentication.

Although not shown in FIG. 5A, it will be appreciated that the RAN 103/104/105 and/or RAN 103b/104b/105b and/or the core network 106/107/109 may be in direct or indirect communication with other RANs that employ the same RAT as the RAN 103/104/105 and/or RAN 103b/104b/105b or a different RAT. For example, in addition to being connected to the RAN 103/104/105 and/or RAN 103b/104b/105b, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d, 102e to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 and/or RAN 103b/104b/108B or a different RAT.

Some or all of the WTRUs 102a, 102b, 102c. 102d in the communications system 100 may include multi-mode capabilities, e.g., the WTRUs 102a, 102b, 102c, 102d, and 102e may include multiple transceivers for communicating with different wireless networks over different wireless links. For example, the WTRU 102e shown in FIG. 5A may be configured to communicate with the base station 114a, which may employ a cellular-based radio technology, and with the base station 114c, which may employ an IEEE 802 radio technology.

FIG. 5B is a block diagram of an example apparatus or device configured for wireless communications in accordance with the aspects illustrated herein, such as for example, a WTRU 102. As shown in FIG. 5B, the example WTRU 102 may include a processor 118, a transceiver 120, a transmit/receive element 122, a speaker/microphone 124, a keypad 113, a display/touchpad/indicators 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an example. Also, in some cases the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 5B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 5B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in some cases, the transmit/receive element 122 may be an antenna configured to transmit and/or receive RF signals. In some cases, the transmit/receive element 122 may be an emitter/detector configured to transmit and/or receive IR. UV, or visible light signals, for example. In some cases, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 5B as a single element, the WTRU 102 may include any number of transmit/receive elements 122. More specifically, the WTRU 102 may employ MIMO technology. Thus, in some cases, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad/indicators 128 (e.g., a liquid crystal display (LCD) display unit or organic light-emitting diode (OLED) display unit). The processor 118 may also output user data to the speaker/microphone 124, the keypad 126, and/or the display/touchpad/indicators 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In some cases, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries, solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an aspect.

The processor 118 may further be coupled to other peripherals 138, which may include one or more software and/or hardware modules that provide additional features, functionality and/or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The WTRU 102 may connect to other components, modules, or systems of such apparatuses or devices via one or more interconnect interfaces, such as an interconnect interface that may comprise one of the peripherals 138.

FIG. 5C is a system diagram of the RAN 103 and the core network 106. As noted above, the RAN 103 may employ a UTRA radio technology to communicate with the WTRUs 102a, 102b, and 102c over the air interface 115. The RAN 103 may also be in communication with the core network 106. As shown in FIG. 5C, the RAN 103 may include Node-Bs 140a. 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an aspect of the disclosure.

As shown in FIG. 5C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macro-diversity, security functions, data encryption, and the like.

The core network 106 shown in FIG. 5C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a. 102b. 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 5D is a system diagram of the RAN 104 and the core network 107. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an aspect of the disclosure. The eNode-Bs 160a, 160b, 160c may each include one or more transceivers for communicating with the WTRUs 102a, 102b, 102c over the air interface 116. In some cases, the eNode-Bs 160a, 160b. 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink and/or downlink, and the like. As shown in FIG. 5D, the eNode-Bs 160a, 160b, 160c may communicate with one another over an X2 interface.

The core network 107 shown in FIG. 5D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b. 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 5E is a system diagram of the RAN 105 and the core network 109. The RAN 105 may be an access service network (ASN) that employs IEEE 802.16 radio technology to communicate with the WTRUs 102a, 102b, and 102c over the air interface 117. As will be further discussed below, the communication links between the different functional entities of the WTRUs 102a, 102b, 102c, the RAN 105, and the core network 109 may be defined as reference points.

As shown in FIG. 5E, the RAN 105 may include base stations 180a, 180b, 180c, and an ASN gateway 182, though it will be appreciated that the RAN 105 may include any number of base stations and ASN gateways while remaining consistent with an aspect of the disclosure. The base stations 180a, 180b, 180c may each be associated with a particular cell in the RAN 105 and may include one or more transceivers for communicating with the WTRUs 102a, 102b, 102c over the air interface 117. In some cases, the base stations 180a, 180b. 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, and 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, and 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 5E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, and 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a. 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 5E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a. 102b, 102c between the RAN 105 and the other ASNs. The communication link between the core network 109 and the other core networks may be defined as an R5 reference, which may include protocols for facilitating interworking between home core networks and visited core networks.

The core network entities described herein and illustrated in FIGS. 5A, 5C, 5D, and 5E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIGS. 5A, 5B, 5C, 5D, and 5E are provided by way of example only, and it is understood that the subject matter disclosed and claimed herein may be embodied or implemented in any similar communication system, whether presently defined or defined in the future.

FIG. 5F is a block diagram of an exemplary computing system 90 in which one or more apparatuses of the communications networks illustrated in FIGS. 5A, 5C, 5D and 5E may be embodied, such as certain nodes or functional entities in the RAN 103/104/105, Core Network 106/107/109, PSTN 108, Internet 110, or Other Networks 112. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, and/or any other functionality that enables the computing system 90 to operate in a communications network. Coprocessor 81 is an optional processor, distinct from main processor 91, that may perform additional functions or assist processor 91. Processor 91 and/or coprocessor 81 may receive, generate, and process data related to the methods and apparatuses disclosed herein. In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that may not easily be modified. Data stored in RAM 82 may be read or changed by processor 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it may not access memory within another process's virtual address space unless memory sharing between the processes has been set up.

In addition, computing system 90 may contain peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adapter 97, that may be used to connect computing system 90 to an external communications network, such as the RAN 103/104/105, Core Network 106/107/109. PSTN 108, Internet 110, or Other Networks 112 of FIGS. 5A, 5B, 5C, 5D, and 5E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

FIG. 5G illustrates an example communications system 111 in which the methods and apparatuses described and claimed herein may be an aspect of. As shown, the example communications system 111 may include wireless transmit/receive units (WTRUs) A, B, C, D, E, F, a base station, a V2X server, and a RSUs A and B, though it will be appreciated that the disclosure contemplates any number of WTRUs, base stations, networks, and/or network elements. One or several or all WTRUs A, B, C, D, E may be out of range of the network (for example, in the figure out of the cell coverage boundary shown as the dash line). WTRUs A, B, C form a V2X group, among which WTRU A is the group lead and WTRUs B and C are group members. WTRUs A, B, C, D, E, F may communicate over Uu interface or Sidelink (PC5) interface.

It is understood that any or all of the apparatuses, systems, methods and processes described herein may be embodied in the form of computer executable instructions (e.g., program code) stored on a computer-readable storage medium which instructions, when executed by a processor, such as processors 118 or 91, cause the processor to perform and/or implement the systems, methods and processes described herein. Specifically, any of the steps, operations or functions described herein may be implemented in the form of such computer executable instructions, executing on the processor of an apparatus or computing system configured for wireless and/or wired network communications. Computer readable storage media include volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

### Definitions

Provided below are definitions for abbreviations found within the body of the disclosure.

| | |
|---|---|
| API | Application Programming Interface |
| CSP | Cloud Service Provider |
| EDA | Exploratory Data Analysis |
| ELT | Extract, Load, Transform |
| ETL | Extract, Transform, Load |
| FL | Federated Learning |
| GUI | Graphical User Interface |
| IE | Informational Element |
| IP | Internet Protocol |
| ML | Machine Learning |
| NLP | Natural Language Processing |
| RCA | Root Cause Analysis |
| SDN | Software-Defined Networking |
| SMOTE | Synthetic Minority Over-Sampling Technique |
| URI | Uniform Resource Identifier |
| URL | Uniform Resource Locator |

Provided below are definitions for terms found within the body of the disclosure.

| | |
|---|---|
| FL data preparation | Performing operations, on a federated dataset spanning across multiple |
| | FL clients, such as correcting inconsistencies, missing or outlier values; |
| | enriching and transforming data, feature engineering, labelling data for |
| | training of an ML algorithm or model in a federated manner. |
| FL user | A user apparatus (e.g., computer, smart phone, tablet) hosting compute, |
| | memory and network connectivity resources capable of hosting a user |
| | application (e.g., web browser, app) which a user uses to perform FL |
| | centric operations with a FL service such as but not limited to FL data |
| | preparation. |
| FL service | A network apparatus (e.g., device, gateway or server) hosting compute, |
| | memory and network connectivity resources capable of hosting a FL |
| | service which performs FL management operations such as but not |
| | limited to FL data preparation. |
| FL client | A network apparatus (e.g., device, gateway or server) hosting compute, |
| | memory and network connectivity resources capable of hosting a FL |
| | client (e.g., client application) which registers to a FL service and also |
| | hosts local data that may be used for training machine learning models in |
| | a federated manner. |

What is claimed is:

1.-20. (canceled)

21. An apparatus configured to implement a federated learning (FL) service, the apparatus comprising a processor configured to:
receive a request related to a dataset for a machine learning (ML) application from a FL user application, the request indicating requirements comprising an indication of a dataset size and an indication of a feature for dataset analysis;
send one or more data analysis requests to one or more FL clients, the one or more data analysis requests comprising a dataset identifier, a first dataset feature, and an indication of a dataset function;
receive one or more data analysis responses, from the one or more FL clients;
send data analysis information aggregated from the one or more data analysis responses to the FL user application;
receive a data preparation request from the FL user application, the data preparation request comprising the dataset identifier and an indication of a data preparation function;
send one or more data preparation requests to at least one of the one or more FL clients, the one or more data preparation requests indicating the dataset identifier and an indication of the data preparation function;
receive at least one data preparation response from the at least one of the one or more FL clients; and
send data preparation information aggregated from the one or more data analysis responses to the FL user application.

22. The apparatus of claim 21, wherein the first dataset feature comprises independent variables that assist in building a ML model to predict a target feature.

23. The apparatus of claim 21, wherein the data analysis responses further comprise descriptive data statistics, and wherein the descriptive data statistics comprise one or more of counts, numerical summaries, graphical summaries, outliers or outlier detection methods.

24. The apparatus of claim 21, wherein the data preparation request further comprises a feature identifier, wherein the feature identifier is associated with a second dataset feature and a desired data preparation requirement.

25. The apparatus of claim 24, wherein the feature identifier comprises data preparation requirements, and wherein the desired data preparation requirement comprises standardized data formatting, handling missing values, handling outliers, handling data imbalances, feature engineering, or feature selection.

26. The apparatus of claim 25, wherein the feature engineering comprises encoding of categorical values, scaling, or mathematical transformations, and wherein the feature selection comprises one or more of filtering methods, wrapper methods, or embedded methods.

27. A method performed by a federated learning (FL) service, the method comprising:
receiving a request related to a dataset for a machine learning (ML) application from a FL user application, the request indicating requirements comprising an indication of a dataset size and an indication of a feature for dataset analysis;
sending one or more data analysis requests to one or more FL clients, the one or more data analysis requests comprising a dataset identifier, a first dataset feature, and an indication of a dataset function;
receiving one or more data analysis responses, from the one or more FL clients;
sending data analysis information aggregated from the one or more data analysis responses to the FL user application;
receiving a data preparation request from the FL user application, the data preparation request comprising the dataset identifier and an indication of a data preparation function;
sending one or more data preparation requests to at least one of the one or more FL clients, the one or more data preparation requests indicating the dataset identifier and an indication of the data preparation function;
receiving at least one data preparation response from the at least one of the one or more FL clients; and
sending data preparation information aggregated from the one or more data analysis responses to the FL user application.

28. The method of claim 27, wherein the first dataset feature comprises independent variables that assist in building a ML model to predict a target feature.

29. The method of claim 27, wherein the data analysis responses further comprise descriptive data statistics, and wherein the descriptive data statistics comprise one or more of counts, numerical summaries, graphical summaries, outliers or outlier detection methods.

30. The method of claim 27, wherein the data preparation request further comprises a feature identifier, wherein the feature identifier is associated with a second dataset feature and a desired data preparation requirement.

31. The method of claim 30, wherein the feature identifier comprises data preparation requirements, and wherein the desired data preparation requirement comprises standardized data formatting, handling missing values, handling outliers, handling data imbalances, feature engineering, or feature selection.

32. The method of claim 31, wherein the feature engineering comprises encoding of categorical values, scaling, or mathematical transformations, and wherein the feature selection comprises one or more of filtering methods, wrapper methods, or embedded methods.

33. An apparatus configured as a federated learning (FL) client, the apparatus comprising a processor configured to:
receive one or more data analysis requests from one or more FL services, the one or more data analysis requests being associated with a dataset for a machine learning (ML) application accessed by a FL user application, the one or more data analysis requests comprising a dataset identifier, a dataset feature, and an indication of a dataset function;
send one or more data analysis responses to the one or more FL services;
receive one or more data preparation requests from at least one of the one or more FL services, the one or more data preparation requests indicating the dataset identifier and an indication of a data preparation function; and
send at least one data preparation response to the one or more FL services.
